(19) United States
(12) Patent Application Publication
(10) Pub. No.: US 2005/0000631 A1
(43) Pub. Date: Jan. 6, 2005

(54) Method for patterning of three-dimensional surfaces

(76) Inventors: Hannu Salo, Rahja (FI); Juha Pimia, Varkaus (FI); Arto Niska, Joensuu (FI)

Correspondence Address: Swidler Berlin Shereff Friedman, LLP, 3000 K Street, N.W., Suite 300, Washington, DC, 20007-5116, US

(21) Appl. No.: 10/479,212

(22) PCT Filed: May 31, 2002
(86) PCT No.: PCT/FI02/00469

(30) Foreign Application Priority Data
Jun. 1, 2001 (FI) 20011147

(51) Int. Cl. B44C 1/165; B44C 1/00

(52) U.S. Cl. 156/230; 156/234

(57) ABSTRACT

In a method for patterning of three-dimensional surfaces, the paterns is first formed on a medium, from which it is transferred to the surface of an object to be patterned. The method comprises the following steps: a) providing a medium (1) having a release layer (1b), b) treating the release layer (1b) on the surface of the medium (1) with an adhesion promoter, c) forming a pattern (2) onto the surface of the treated medium (1), on top of the adhesion promoter, d) separating the pattern (2) from the medium (1) at the release layer (1b) in such a way that the adhesion promoter remains attached to the pattern (2), and e) placing the pattern (2) onto the three-dimensional surface of an object (4), with the adhesion promoter against the surface of the object (4).

The invention relates to a method for patterning of three-dimensional surfaces according to the preamble of appended claim 1. In this case, patterning refers to the bringing of any two-dimensional image on a surface. In particular, it refers to the decoration of a three-dimensional object surface with a motif which can be a natural image resembling a photo, or a fully abstract pattern, or anything therebetween, made to the customer.

The decoration of various three-dimensional surfaces has become popular in recent years. The purpose of such decoration is also so-called personification, that is, to make the pattern to be placed on the surface personal, wherein the pattern must be custom-made. An alternative for this is to have as large a variety of patterns as possible, wherein the customer can make a selection from a number of alternatives. In this case, the patterns can also be made in serial production, but the series corresponding to one pattern will remain small.

It is known to make a decoration by manual painting. Although even a good precision can be achieved in this way, the work is time-consuming and the cost of work becomes high. For this reason, an aim has been to develop methods whereby the pictorial motif could be transferred to the surface of an object at one time. This also provides the possibility to use the same motifs several times, for example in serial production.

The patterning of three-dimensional surfaces is more or less difficult, depending on the surface topography. It is particularly difficult to pattern the surfaces of such objects whose section is curvilinear (deviating from the straight line) in two planes transverse to each other. The surfaces of such pieces differ from the shape of a cylindrical or conical surface. The decal process is well known in the decoration of cylindrical or conical pieces, and this technology is disclosed e.g. in U.S. Pat. No. 5,948,728. This patent describes a method in which a personified image is formed onto a mug from a photograph by first forming it into a transfer image onto a suitable medium, the pattern included in the transfer image being transferred by means of heat onto the surface of the mug by utilizing known techniques (sublimation dyes).

Furthermore, such methods are known, in which a pattern is formed onto a base paper whereafter lacquer is applied on top of it, and the lacquer and the pattern can be released by moistening the paper at a release layer in the base paper, as disclosed e.g. in U.S. Pat. Nos. 4,529,654 and 4,049,860. These patents do not discuss more closely the special demands caused by topography.

It is common to all the above-described techniques that the pattern is first formed on a medium and the pattern is transferred from this medium to the surface of the object to be decorated by means of a transfer method based on the use of either thermally sublimable dyes or a pattern layer releasable from back layers.

It is an aim of the invention to present a novel method for the individually made or personified patterning of three-dimensional pieces, whereby a good resolution of the pattern is obtained if necessary, even very difficult surfaces can be patterned which are curvilinear in two directions and which may also have recesses and openings, and by which method it is possible to avoid distortions of the pattern caused by said topography. The invention is particularly intended for the patterning of covers of electronic devices, such as mobile phones. The method is suitable for the patterning of the surface of the object both on a single order and in batches of varying size with the same pictorial motif. To attain the above-described aims, the method according to the invention is primarily characterized in what will be presented in the characterizing part of the appended claim 1.

The invention comprises the following steps:
a) providing a medium having a release layer or release surface,
b) treating the release layer or release surface on top of the medium with a material which forms a film,
c) making a pattern on the surface of the medium on top of the film,
d) separating the pattern from the medium at the release layer or release surface in such a way that the film remains attached to the pattern, and
e) placing the pattern on the three-dimensional surface of an object by means of a layer formed by an adhesion promoter, which comes against the surface of the object.

The pattern to be transferred to the surface of the object and the adhesion promoter are preferably both made of an elastic-plastic material. It is typical of such materials that when in the solid state, they are capable of stretching without cracks. The material does not necessarily, need to be elastic, that is, the deformation does not necessarily need to be reversible. The pattern can be of an elastic-plastic ink, and the adhesion promoter can be of an elastic-plastic adhesive film, particularly one whose adhesion can be improved by heating. Thus, the combination film formed by the pattern and the adhesion promoter is elastic-plastic, and it conforms to the varying topography of the surface of the object, such as its curvature in different directions as well as to minor deviations, such as recesses and openings, in such curved general shape which is e.g. convex seen from the side to be coated. Thanks to the used adhesion promoter, the elastic-plastic pattern can be made to adhere well and permanently to different points on the surface.

The adhesion promoter may be of an elastic-plastic hot melt adhesive, hot seal coating, or PSA (pressure sensitive adhesive).

According to an advantageous embodiment, a protective film is applied on the printed pattern before releasing the pattern from the medium, that is, this can be made after the printing of the pattern. The protective film facilitates the mechanical handling of the combination film formed by the pattern and the adhesion promoter. The protective film may be of a suitable polymer. By means of the protective film, the pattern to be transferred can be handled easier during the transfer phase, although it is not necessary for carrying out the invention. The protective film may be temporary, that is, it can be released after the pattern has been attached to the surface of the object. The protective film may also be left in its place on the pattern and be cured later, wherein it remains in the product. A protective lacquer is preferably applied on the pattern in the last step, particularly if the temporary protective film has been removed from the top of the pattern.

The method according to the invention preferably comprises the forming of an image file corresponding to the pattern by a data processing technique before the pattern is formed on the surface of the medium. In this case, the pattern can be formed on the basis of the image file by a suitable printing method on the surface of the medium, and it can be e.g. edited or corrected when it is in the digital form.

In the following, the invention will be described in more detail with reference to the appended drawings, in which

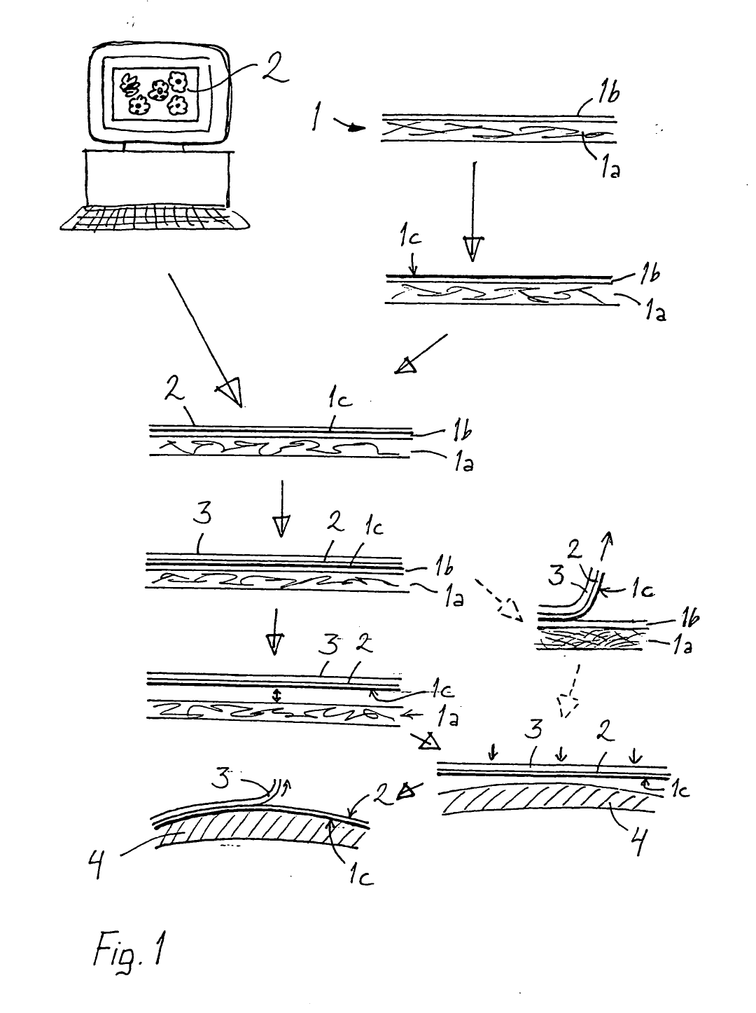

FIG. 1 shows schematically the different steps of the method according to the invention, and

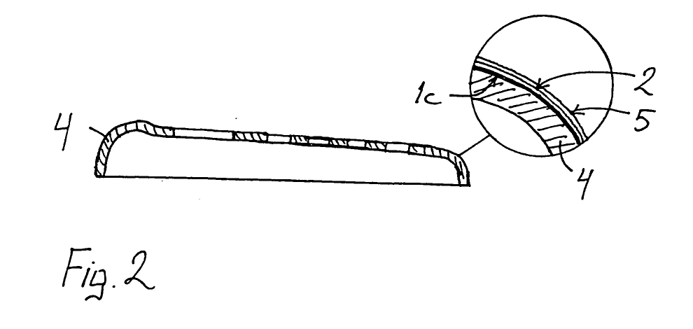

FIG. 2. shows a cross-section of an object patterned by the method according to the invention.

FIG. 1 shows the method according to the invention in successive steps. First, an image file is formed of the pictorial motif by using a data processing technique. The image file may be generated for example with a suitable application program in a computer, for example with a PC. The image may originate from another source, for example it may be originally recorded by a camera technique from an object, or it may have been acquired as an image file via another way. The program can be used to edit the original pictorial motif, for example to take into account the general geometry of the piece to be coated in advance, to minimize distortions, or changes can be made in the pictorial motif itself. Similarly, the pictorial motif can be originally created by the data processing technique.

Before the pattern is applied on the surface of the object, a physical carrier material is needed to implement the transfer. For this purpose, there is a medium 1 which can be of a suitable printing paper. Such printing paper has a body layer 1a which can be of a suitable base paper. On top of the body layer 1a, a release layer 1b is formed, which can be of a suitable water-soluble polymer, such as polyvinyl alcohol. The medium 1 can be e.g. a regular commercial printing paper, but depending on the printing method, it can also be designed especially for the method.

In the following step, an adhesion promoter is applied on top of the release layer 1b of the medium 1. This material is preferably a polymer-based substance which forms an elastic-plastic film after the liquid carrier material used in the application has evaporated. This film formed by the adhesion promoter is indicated with the reference numeral 1c. For example, it is possible to use a coating liquid marketed under the trade name “TOPAZ” (manufactured by Indigo Electronic Printing Systems Ltd.), which is a coating agent containing a polyamide based hot-melt adhesive in an organic solvent and which forms an elastic-plastic film after it has dried.

One advantageous alternative for the material of the film 1c of the adhesion promoter are so-called heat-seal adhesives, which can be activated above a given temperature. The attachment of the film formed of these is thus based on the cross-linking of polymers. The film can be formed of a water-based dispersion onto a suitable carrier material forming the body layer 1a, and a release layer is not necessarily needed. It is possible to select such a heat-seal adhesive and such a body layer that their adhesion is weak to such an extent that the surface layer can be released as an integral film together with the image from the body layer by mechanical peeling without a need to form an intermediate third material layer, whose disappearance (e.g. dissolution) would cause the layers to be separated. The body layer can be, for example, paper with a siliconized surface or a plastic film. A typical heat-seal adhesive is Lioseal A 8127-21, manufactured by Henkel KgaA, which is known as a water-based heat-seal coating intended for adhesive plastic films. This film also has good stretchability (more than 100%) before its activation.

In the next step, the pattern is output from the image file onto the layer 1c of the adhesion promoter situated on the surface of the medium 1. This printing step can be taken in a colour printer or in another suitable printing unit to which the data of the image file can be transferred from the data processor. In the printing, elastic-plastic inks are used, which are compatible with the surface film 1c (adhesion promoter) of the medium 1. Such inks include polymer particles which contain a colour pigment and whose polymer material forms the basic substance of the pattern and determines the physical properties of the pattern (stretchability etc.). The ink may be in liquid form, the polymer particles being in a carrier liquid, or in powder form. Suitable elastic-plastic inks include, for example, inks marketed under the trade name Electro Ink Mark III (manufactured by Indigo Electro Printing Systems Ltd.), which are based on copolymers of ethylene, or polyester based inks by Xeikon N.V. Such elastic-plastic inks may exist in different colours, that is, they can be used to implement multi-colour printing. After the printing, a medium is provided, in which a two-dimensional pattern 2 in the form of a layer consisting of said ink and intended for the patterning of an object, is attached on top of the layer 1c of the adhesion promoter. The film of the adhesion promoter acts as the cohesive structure for the pattern 2 for its further processing.

A particularly suitable colour printing method for applying elastic ink as the pattern 2 on the surface of the medium 1 is the digital printing method which is based on a digital offset printing ink, a set of colour rolls, and a rubber cylinder, from which the pattern to be printed is transferred to the medium in a way similar to offset printing. In the transfer of the image file onto the medium, an essential role is played by an electronic printing plate on the surface of a rotating drum, to which the printing ink is adhered according to the electrical charge and from which it is transferred onto the rubber surface around the cylinder (rubber cylinder). From the rubber surface, a polymeric tacky film is transferred by means of press between the rubber cylinder and a counter cylinder to the medium 1 supplied from between the cylinders. When the above-mentioned method is used in multi-colour printing, the same medium is naturally printed with different colours in succession. Depending on the printing method, the colours can also be printed at one time.

In the next step, a polymer film 3 is applied onto the pattern 2 by a suitable application method, for example by spraying. The purpose of this polymer film is to facilitate the handling of the pattern 2 to be transferred. The polymer film 3 is of such quality that it has a lower adhesion to the pattern 2 than the pattern 2 has to the layer 1c of the adhesion promoter, and therefore, the substance to be applied onto the pattern 2 can be of any film-forming polymer with these properties. The substance which contains the above-mentioned polymer may be water-based, although the release layer 1b is water-soluble, because the film which forms the pattern 2 is water-tight. If necessary, before the forming of the polymer film 3, on the surface of the pattern 2 a substance can be spread which will promote the later releasing of the film 3 from the surface of the pattern 2.

In the next step, the pattern 2 and the medium 1 are separated from each other at the release layer 1b. The separation can be performed, for example, by moistening the body layer 1a. When water moistens the body layer 1a, it simultaneously dissolves the water-soluble polymer of the release layer 1b. If the body layer 1a is paper, water can well penetrate the release layer 1b, thanks to the porosity of the paper. On the other hand, water will not affect the water-tight layers 1c and 2. In this way, the layer 1c of the adhesion promoter, the pattern 2, and the protective film 3 on top of the pattern 2 can be released together from the rest of the medium 1. If necessary, additives, such as dispersing agents, can be used in water to secure the releasing.

Next, the pattern 2 is brought on top of the object 4 to be patterned having a three-dimensional surface. The transfer to the surface of the object can be performed in a jig with a special structure, to which the object 4 is fixed, for example by pressure. Vacuum and pressure can also be used to force off air left between the film and the surface of the object. The pattern 2 will now adhere to the surface of the object 4 through the layer 1c of the adhesion promoter. The adhesion is strengthened by heating, wherein the adhesion promoter is melted or softened and will glue the pattern 2 firmly to the surface of the object 4. If the material of the adhesion promoter layer is a thermally activatable heat-seal adhesive, the fixing is performed by heating above the activation temperature.

In the next step, the protective film 3 is removed from the surface of the object. If necessary, the object 4 is first brought to a low temperature, to facilitate the release of the film 3. After the release of the film 3, the exposed pattern 2 can be coated with a protective lacquer which forms the final protective layer 5 to prevent scratching. FIG. 2 shows such a finished coated object 4, exemplified with a plastic cover for a mobile phone.

The temporary protective film 3 is not necessarily needed, but it is possible to remove the pattern 2 and the layer 1c of the adhesion promoter together from the rest of the medium 1 and to place them as such on the surface of the object 4, after which the adhesion is secured by heating and the surface is lacquered.

Similarly, the protective film 3 can be left on the pattern and cured later, wherein no lacquering will be needed.

The materials used for forming the protective film can be suitable film-forming water- or solvent-based polymers, such as water-based polyurethane or acryl polyurethane. Substances which form permanent protective films include UV curable polyurethanes, which will be discussed in the following.

It is possible that the lacquer which forms the final protective layer 5 for the surface pattern of the object, can be sprayed or applied in some other way onto the pattern 2 when the pattern is still attached to the medium 1. When this lacquer layer is still in the elastic-plastic state, the pattern 2 and the adhesion promoter layer 1c underneath it can be removed from the medium. After the pattern has been pressed and fixed to the surface of the object 4, the surface lacquer film can be subjected to final curing. The material used for forming such a protective layer 5 can be a suitable lacquer which can be applied in a water-based state so that when dried, it forms a stretchable film. It is possible to use, for example, UV curable polyurethane lacquers which have a good stretchability (preferably more than 100%). In this case, the protective layer can be formed by first applying the lacquer onto a plastic film, to which the lacquer has poor adhesion and which forms a temporary carrier film for the protective layer 5. By means of this plastic film, the protective layer can be laminated on top of the surface layer 1c. The protective layer may adhere already by the effect of a sufficient pressure, but slight heating will provide better adherence. The protective layer 5 will be easily released from its carrier film, after which it can be attached with the pattern 2 to the surface of the object and be cured by UV irradiation. One feasible lacquer to form the protective film, to which the invention is not limited, is Bayhydrol 2317, manufactured by Bayer AG.

The invention is not limited above to substances or materials itemized with given trade names or a given chemical composition, but it is possible to use other substances which meet the same requirements. Instead of paper coated with polyvinyl alcohol, the medium 1 may be of such paper in which a dissolving release layer is not used. The release layer 1b may thus act in such a way that the adhesion promoter layer 1c can be easily detached from its surface. Such a release layer 1b may be, for example, a siliconized surface of the base paper or a corresponding low energy surface (e.g. polyester surface), to which the adhesion promoters used are poorly attached. When the release effect is not based on the disappearance of a material layer from below the film to be transferred, it is also possible to speak about a release surface whose surface properties are important in view of the release. When a low-energy surface is used, the pattern and the adhesion promoter film can be released from the medium 1 by mechanical pulling. This is indicated on the right hand side in FIG. 1.

When the release layer 1b of the medium 1 is of silicone or a corresponding material with a low surface energy, it is also possible to use water-based substances as the adhesion promoters, which form an elastic film after the water has evaporated, for example the above-described heat-seal adhesives which contain cross-linkable polymers.

The invention also covers the idea that the elastic-plastic pattern 2 is formed by a suitable printing method, for example by the above-described digital printing method, first onto the film of the printing medium 1 which has another purpose than to act as a film to attach the pattern onto the surface of the object. After this, it is possible to apply an adhesion promoter layer onto the pattern 2 to form, at this stage, a protective film that facilitates the mechanical handling of the pattern, but which will be used later for attaching the pattern to the surface of the object, for example the above-described heat-seal adhesive containing cross-linking polymers in a water-based dispersion. The films, with the pattern therebetween, can be released together from the printing medium. In the printing, one should take into account that the pattern is formed, in a way, as a mirror image, because it will be turned the other way around when attached to the object. Similarly, the film 1c that is on top of the release layer 1b or release surface, and that will have the pattern on its surfaces should be transparent. Such a film can be formed, for example, of the above-mentioned UV curable polyurethane lacquer which can be used to form the final protective layer for the pattern on the surface of the object, because it will be outermost in the object, with respect to the pattern 2.

The elasticity/plasticity of the printing ink forming the pattern 2 and the elasticity/plasticity of the adhesion promoter layer 1c refers to elasticity/plasticity at room temperature (about 20 degrees centigrade). Thus, the thin film formed of the pattern 2 and the adhesion promoter layer 1c and being elastic-plastic throughout, can be easily made to conform to the shapes of the above-described objects with difficult surface topographies. The elastic-plastic two-dimensional pattern 2 formed by printing colour or ink will thus be stretched along with the carrier film (the film 1c formed by the adhesion promoter) and will not crack. When the layer 1c, the pattern 2 and the protective film 3 or protective layer 5 attached onto the pattern 2 (or a combination film in which the layers have been in the reverse order on the printing medium) are transferred together onto the surface of the object, also the protective film or layer must be elastic-plastic, so that the whole combination film would be stretchable at the positioning stage before the final fixing to the surface of the object.

The above-mentioned term elastic-plastic used in connection with the films should be understood so that the film material is stretched without breaking for at least a given distance, preferably more than 100% and may tend to return elastically to its original length at least partly or may remain in the length to which it has been stretched.

The invention suits particularly well to the patterning of the cover structures of electronic devices, especially the plastic covers of mobile phones. Because the printing can be made by digital multi-colour printing starting from an image file which can be created in a variety of ways by using motifs from a number of different sources, the invention makes it possible to pattern the surfaces of objects, such as the plastic covers of mobile phones, in a work made on order in series of different sizes, wherein it is possible to speak of so-called “mass personification”.

Although the invention has been described above by referring to an image which is, at some stage, in the form of an image file, the image can also be formed on the medium by another way by using said materials. For example, it is possible to use such a printing technique, in which the image is formed on a printing plate or the like in another way than on the basis of an image file.

1. A method for patterning of three-dimensional surfaces, in which the image is first formed on a medium, from which it is transferred to the surface of the object to be patterned so that the image is visible on the surface of the object, the method comprising:
a) providing a medium having a release layer or release surface,
b) treating the release layer or release surface on top of the medium with a material which forms a film,
c) forming a pattern onto the surface of the medium, on top of the film,
d) separating the pattern from the medium at the release layer or release surface in such a way that the film remains attached to the pattern, and
e) placing the pattern on the three-dimensional surface of an object by means of an elastic-plastic layer formed by an adhesion promoter, which comes against the surface of the object.

2. A The method according to claim 1, wherein the release layer or release surface on the surface of the medium is treated with an adhesion promoter which forms a film.

3. The method according to claim 1, wherein the film, onto which the pattern is formed, is of an elastic-plastic material.

4. The method according to claim 3, wherein the adhesion promoter is of an elastic-plastic hot melt adhesive, hot seal coating, or (pressure sensitive adhesive).

5. The method according to claim 3, wherein the pattern is formed of an elastic-plastic ink.

6. The method according to claim 1, wherein before the separation of the pattern from the medium, a protective film is applied on the pattern to facilitate the mechanical treatment of the pattern.

7. The method according to claim 1, wherein the release layer of the medium consists of a water-soluble material, such as a water-soluble polymer.

8. The method according to claim 1, wherein the release layer or release surface of the medium consists of a material, from whose surface the film can be mechanically detached, such as silicone or a corresponding material forming a low-energy surface.

9. The method according to claim 1, wherein the fixing of the layer formed by the adhesion promoter to the surface of the object is promoted by means of heat.

10. The method according to claim 1, wherein the surface of the object to be patterned is curved in two sectional planes perpendicular to each other and the surface.

11. The method according to claim 10, wherein the object to be patterned is the cover of an electronic device, such as the cover of a mobile phone.

12. The method according to claim 1, wherein the method also comprises the forming of an image file corresponding to the pattern by a data processing technique before the image is formed on the surface of the medium.
